(19) United States
(12) Patent Application Publication
(10) Pub. No.: US 2024/0334387 A1
(43) Pub. Date: Oct. 3, 2024

(54) COMMUNICATION CONTROL DEVICE, COMMUNICATION CONTROL METHOD, COMMUNICATION SYSTEM, AND PROGRAM

(71) Applicant: NIPPON TELEGRAPH AND TELEPHONE CORPORATION, Tokyo (JP)

(72) Inventors: Shinya TAMAKI, Musashino-shi, Tokyo (JP); Ryota SHIINA, Musashino-shi, Tokyo (JP); Tetsuya SUZUKI, Musashino-shi, Tokyo (JP); Yasutaka KIMURA, Musashino-shi, Tokyo (JP); Tomohiro TANIGUCHI, Musashino, Tokyo (JP)

(73) Assignee: NIPPON TELEGRAPH AND TELEPHONE CORPORATION, Tokyo (JP)

(21) Appl. No.: 18/579,652

(22) PCT Filed: Aug. 2, 2021
(86) PCT No.: PCT/JP2021/028633

§ 371 Date: Jan. 16, 2024

(51) Int. Cl. H04W 64/00; H04W 72/51

(52) U.S. Cl. CPC H04W 64/006; H04W 72/51

(57) ABSTRACT

To solve the above problem, an object of the present invention is to provide a communication control device, a communication control method, a communication system, and a program that do not require addition of a function to facility equipment, for communication resource allocation corresponding to a physical location of a terminal indoors.

The communication system includes a location metadata source (26, 27) in an arbitrary area 5 and a communication control device 35. The communication control device 35 includes: a reception unit 31 that receives information of the location metadata source (26, 27) from a communication terminal 10 in the arbitrary area 5; and a controller 30 that calculates a location of the communication terminal 10 in the arbitrary area 5 on the basis of the information of the location metadata source (26, 27) and allocates a communication resource depending on the location of the communication terminal 10.

### TECHNICAL FIELD

The present disclosure relates to network resource allocation in a communication system.

### BACKGROUND ART

In communication of a wireless local area network (LAN), in a case where there is a plurality of access points having the same service set identifier (SSID), each of terminals 10 normally communicates with an access point 20 having the highest radio wave intensity. For this reason, there has been a problem that it is difficult to optimize allocation to the access point 20 even if there is a bias in a distribution of the terminals 10 as illustrated in FIG. 1.

To solve this problem, in Non Patent Literature 1, as illustrated in FIG. 2, a control node 30 calculates an optimal value for resource distribution (WiSMA: Strategy Management Architecture for Wireless resource optimization). Then, the control node 30 controls the access point 20 to which the terminals 10 are connected on the basis of a result of the calculation. For example, the control node 30 issues a connection change instruction to a terminal 10 that needs to change the access point 20 of a connection destination. However, WiSMA controls only a logical connection configuration based on a MAC address. For this reason, for example, there has been a problem that it is difficult to control the connection destination for each small section in a room.

For this problem, as illustrated in FIG. 3, Non Patent Literature 2 enables precise control for each of physical locations in a room by using visible light of a light source 25 as a control plane. As illustrated in FIG. 2, the control node 30 calculates an optimal value for resource distribution. In the case of this technology, the control node 30 controls a pattern and color of the visible light for each of light sources 25. Specifically, information for guiding the terminal 10 to the access point 20 to be connected is included in the visible light. The terminal 10 is connected to the access point 20 of the connection destination depending on the pattern, color, or the like of the light received.

### CITATION LIST

### Non Patent Literature

Non Patent Literature 1: Tomoki Murakami, Toshiro Nakahira, Hirantha Abeysekera, Koichi Ishihara, Takafumi Hayashi and Hiroyuki Nakamura: WiSMA: strategy management architecture for wireless resource optimization, 2018 International Workshop on Smart Info-Media Systems in Asia (SISA 2018), December 13-14, 2018. P. 307-312.

Non Patent Literature 2: Ryota Shiina, Tomohiro Taniguchi, Shinya Tamaki, Kazutaka Hara, Toshirou Nakahira, Tomoki Murakami, and Kohji Tsuji: A study on optical transmission method for the application of optical wireless to RF control plane, The Institute of Electronics, Information and Communication Engineers (IEICE) 2020 General Conference (B-8-15)

### SUMMARY OF INVENTION

### Technical Problem

However, to implement the technology of Non Patent Literature 2, it is necessary to add a visible light modulation function to the light source and to add a visible light reception function, a demodulation function, and the like to the terminal. As described above, in pinpoint wireless resource allocation corresponding to a physical location of a terminal indoors, there has been a problem that it is necessary to add a function to facility equipment.

Thus, to solve the above problem, an object of the present invention is to provide a communication control device, a communication control method, a communication system, and a program that do not require addition of a function to facility equipment, for communication resource allocation corresponding to a physical location of a terminal indoors.

### Solution to Problem

To achieve the above object, a communication control device according to the present invention grasps a location of a communication terminal in a specific space from a location metadata source, and performs communication control depending on the location.

Specifically, the communication control device according to the present invention includes:
a reception unit that receives information of a location metadata source from a communication terminal in an arbitrary area; and
a controller that calculates a location of the communication terminal in the arbitrary area on the basis of the information of the location metadata source and allocates a communication resource depending on the location of the communication terminal.

In addition, a communication control method according to the present invention includes:
receiving information of a location metadata source from a communication terminal in an arbitrary area;
calculating a location of the communication terminal in the arbitrary area on the basis of the information of the location metadata source; and
allocating a communication resource depending on the location of the communication terminal.

The communication control device and the communication control method estimate the location of the communication terminal from the location metadata source. The location metadata source can be obtained from an existing sensor, a beacon device, a GPS provided in the communication terminal, or the like. If the location of the communication terminal can be grasped, wireless resource allocation (band allocation, beamforming, and the like) can be performed on the basis of a distribution of communication terminals. Thus, the present invention can provide a communication control device and a communication control method that do not require addition of a function to facility equipment, for communication resource allocation corresponding to a physical location of a terminal indoors.

The communication control device according to the present invention uses a low layer communication protocol for communication of the information of the location metadata source. By using the low layer communication protocol, data of the location metadata source can be collected with a low load and a low delay. In other words, by collecting location information with a low delay, the location of the communication terminal can be grasped in real time and with high accuracy.

The reception unit of the communication control device according to the present invention also receives acceleration acquired by the communication terminal together with the information of the location metadata source. It is possible to improve accuracy of location estimation of the communication terminal and predict movement destination of the communication terminal.

A communication system according to the present invention includes the location metadata source in the arbitrary area, and the communication control device.

The present invention is a program for causing a computer to function as the communication control device. The communication control device of the present invention can also be implemented by the computer and the program, and the program can be recorded in a recording medium or provided through a network.

Note that the inventions described above can be combined in any possible manner.

### Advantageous Effects of Invention

The present invention can provide a communication control device, a communication control method, a communication system, and a program that do not require addition of a function to facility equipment, for communication resource allocation corresponding to a physical location of a terminal indoors.

### BRIEF DESCRIPTION OF DRAWINGS

FIG. 1 is a diagram illustrating a technique related to the present invention.

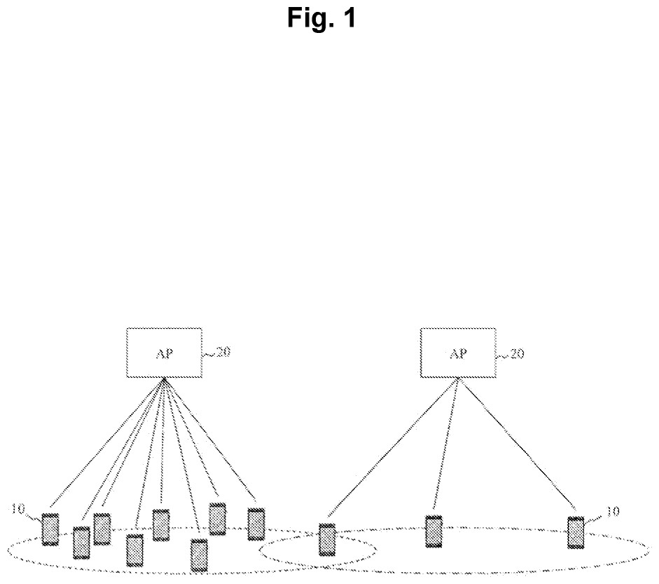

FIG. 2 is a diagram illustrating a technique related to the present invention.

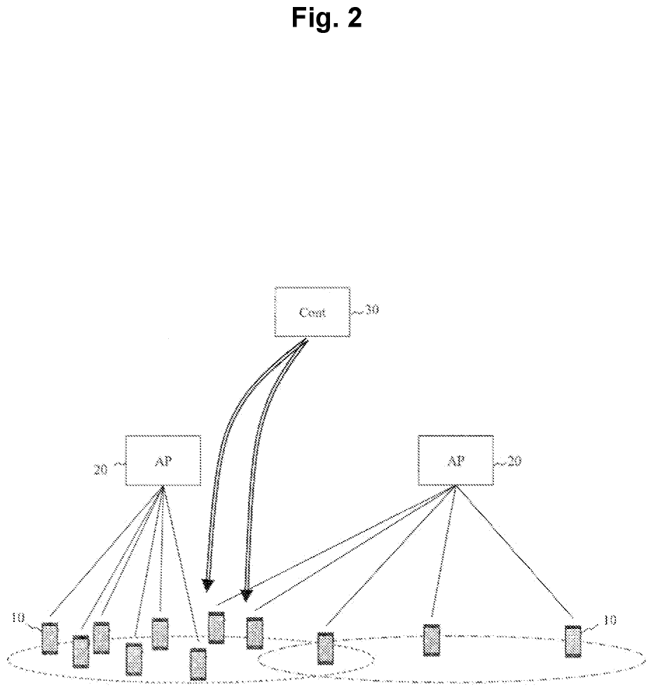

FIG. 3 is a diagram illustrating a technique related to the present invention.

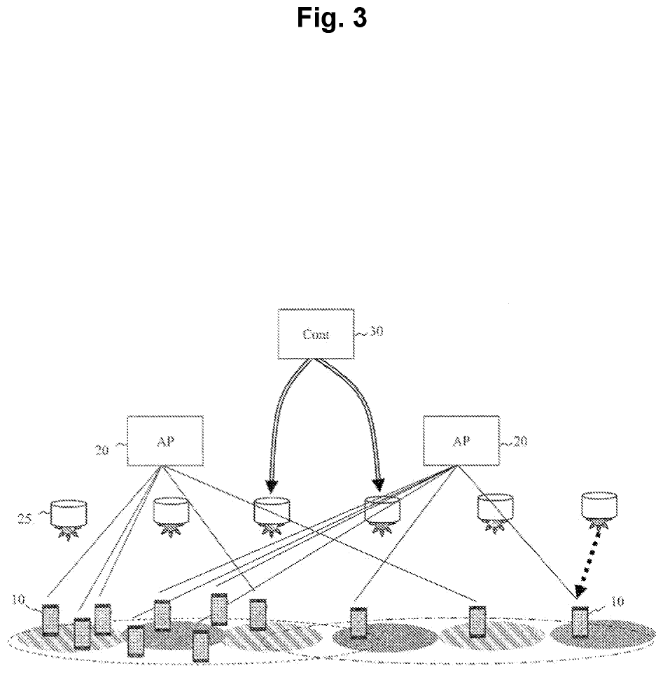

FIG. 4 is a diagram illustrating a communication system according to the present invention.

FIG. 5 is a diagram illustrating operation of the communication system according to the present invention.

FIG. 6 is a diagram illustrating operation of the communication system according to the present invention.

FIG. 7 is a diagram illustrating operation of the communication system according to the present invention.

FIG. 8 is a diagram illustrating a communication control method according to the present invention.

FIG. 9 is a diagram illustrating a communication control device according to the present invention.

### DESCRIPTION OF EMBODIMENTS

Embodiments of the present invention will be described with reference to the accompanying drawings. The embodiments described below are examples of the present invention, and the present invention is not limited to the following embodiments. Note that components having the same reference numerals in the present specification and the drawings indicate the same components.

### First Embodiment

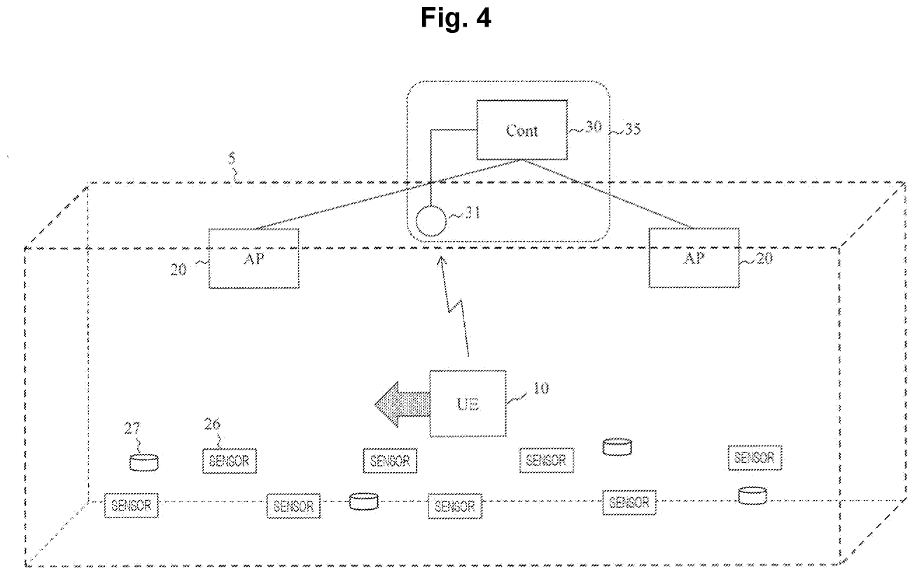

FIG. 4 is a diagram illustrating a communication system of the present embodiment. The communication system includes a location metadata source (26, 27) in an arbitrary area 5 and a communication control device 35. The communication control device 35 includes: a reception unit 31 that receives information of the location metadata source (26, 27) from a communication terminal 10 in the arbitrary area 5; and a controller 30 that calculates a location of the communication terminal 10 in the arbitrary area 5 on the basis of the information of the location metadata source (26, 27) and allocates a communication resource depending on the location of the communication terminal 10.

In the communication system, it is assumed that locations of a beacon device 27, a sensor 26, and a wireless access point 20 installed in the arbitrary area 5 can be accurately grasped by collecting and analyzing sensing information. Note that the sensor 26 can detect a location, acceleration, temperature, sound, a line of sight of a person, an image, wireless information, and the like, and transmit them to the communication control device 35 as sensing information including information for identifying the sensor 26 itself (for example, a MAC address).

The communication control device 35 performs:
on the basis of information obtained from the sensor 26, the beacon device 27, and the access point 20, grasping of a locational relationship among them in the arbitrary area 5;
on the basis of information of acceleration and beacon information (unique numbers, signal strengths, and the like of the sensor 26 and the beacon device 27) collected from the communication terminal 10 with a low delay through a low layer communication protocol, grasping of a current location of the communication terminal 10 in the arbitrary area 5; and
on the basis of the locational relationship among the sensor 26, the beacon device 27, and the access point 20, and information (for example, MAC address) for identifying an individual of the communication terminal 10, allocation of a wired/wireless communication resource (band, wireless/light beam, or the like) to the terminal.

The communication terminal 10 outputs information on a BLE beacon, a sensor, and the like received to the communication control device 35. In addition to the above, the communication terminal 10 may also output sensor information such as acceleration to the communication control device 35. Here, transmission from the communication terminal 10 to the communication control device 35 is preferably performed by low layer communication. Note that the “low-layer communication” and the “low layer communication protocol” mean protocols corresponding to the second layer and the third layer of the OSI reference model.

The controller 30 collates the locational relationship among the access point 20, the sensor 26, and the beacon device 27 with a real-time location and acceleration information of the communication terminal 10 to estimate a physical location of the communication terminal 10. The controller 30 performs the following control on each of wireless access points 20 under the control thereof.
(1) Fine control of access point 20 to which communication terminal 10 should be connected depending on location (resolution determined by number of sensors 26 and beacon devices 27, shape of arbitrary area 5)
(2) Optimal resource allocation by beamforming aiming communication terminal 10 at pinpoint
(3) Resource allocation focusing on communication of specific communication terminal 10 during congestion

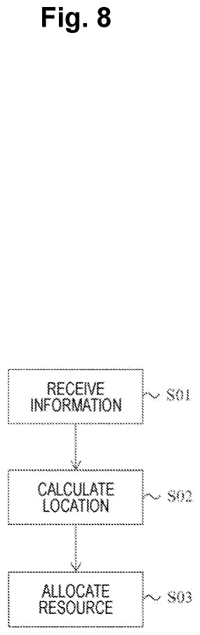

FIG. 8 is a diagram illustrating a communication control method performed by the communication system. The communication control method includes:
receiving information of a location metadata source from the communication terminal 10 in the arbitrary area 5 (step S01);
calculating a location of the communication terminal 10 in the arbitrary area 5 on the basis of the information of the location metadata source (step S02); and allocating a communication resource depending on the location of the communication terminal 10 (step S03).

Here, the location metadata source may be a GPS, a BLE beacon, or the like, or may be an IoT sensor group including a mechanism capable of grasping location information. That is, any means may be used as long as the means can specify the location of the communication terminal 10.

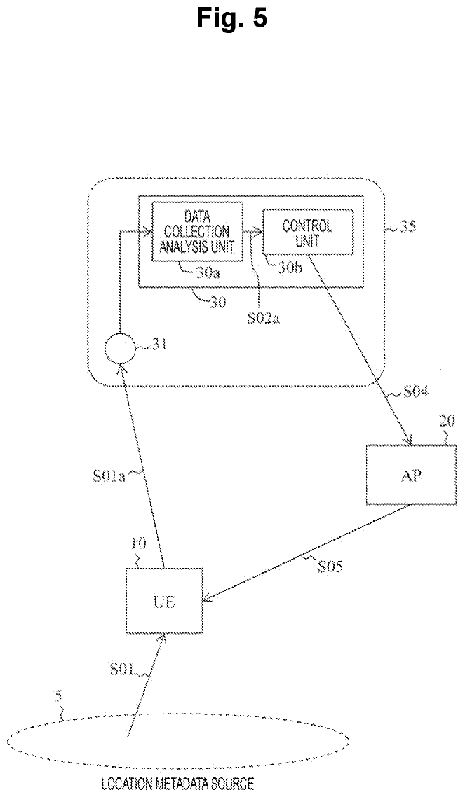

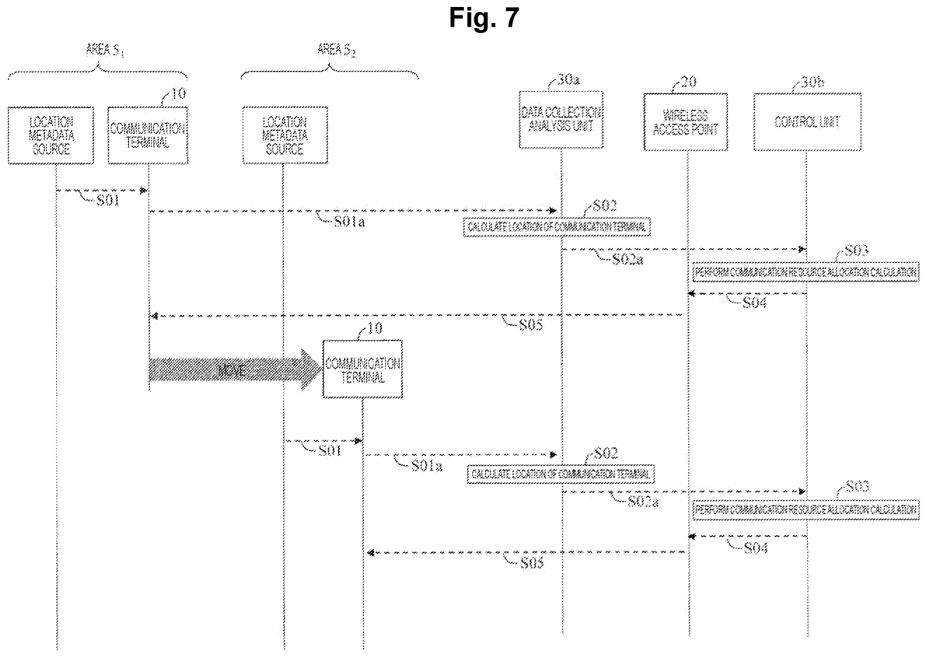

First, basic operation of the communication system will be described with reference to FIGS. 5 and 7. The communication terminal 10 acquires information regarding a location of the communication terminal 10 itself from the location metadata source (step S01). Here, the communication terminal 10 may also acquire location information on the location metadata source itself. Then, the communication terminal 10 transmits the information to the reception unit 31 of the communication control device 35 (step S01a). Information for grasping locations of the communication terminal and the sensor group is transmitted to the communication control device 35 with a low load and a low delay by using a low layer communication protocol. By collecting location information with a low delay, the locations can be grasped in real time with high accuracy.

The information received by the reception unit 31 is transferred to the data collection analysis unit 30a. The data collection analysis unit 30a collects and analyzes information from the sensor and the communication terminal, and calculates the location (for example, three-dimensional coordinates) of the communication terminal 10 (step S02). A result of calculation by the data collection analysis unit 30a is transferred to a control unit 30b (step S02a).

The control unit 30b grasps the location of the communication terminal 10 and performs communication resource allocation calculation (step S03). The control unit 30b notifies the wireless access point 20 of calculated communication resource allocation as a control signal (step S04). The wireless access point 20 executes allocation of a communication resource depending on the location of the communication terminal 10 in accordance with the control signal (step S05). The allocation of the communication resource is, for example, band allocation, beamforming in the case of wireless communication, or directing the optical axis in the case of visible light communication.

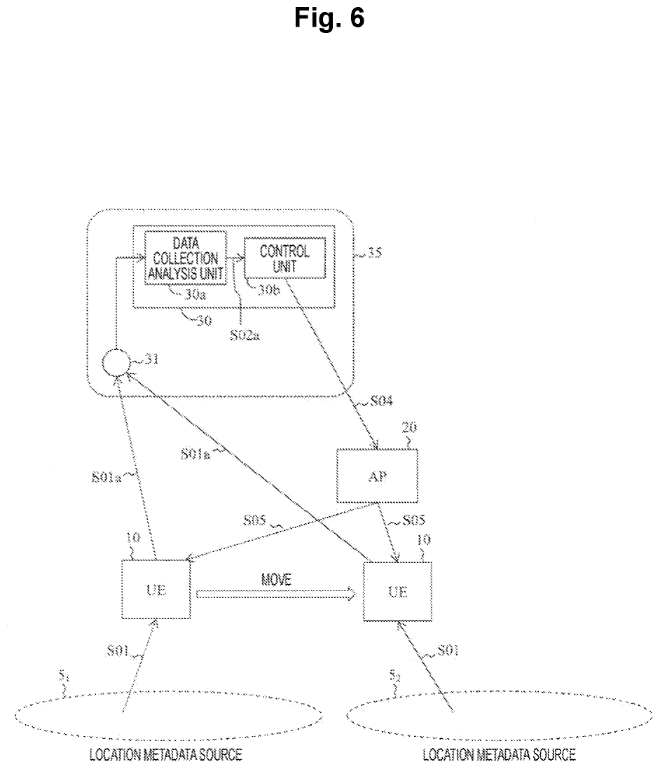

Next, a description will be given of operation when the communication terminal 10 moves from an arbitrary area 51 to an arbitrary area 52 in the present communication system with reference to FIGS. 6 and 7. In FIG. 6, a dotted line is a communication path before the communication terminal 10 moves, and a solid line is a communication path after the communication terminal 10 moves.

The data collection analysis unit 30a confirms received acceleration data of the communication terminal 10, and determines that the communication terminal has moved in a case where the acceleration exceeds a predetermined threshold value. Thereafter, as described with reference to FIGS. 5 and 7, steps S01 to S02a are performed. Note that movement of the communication terminal 10 is not limited to the case of straddling different areas as illustrated in FIG. 6, and may be movement within the same area.

The control unit 30b grasps the location of the communication terminal 10 and performs communication resource allocation calculation (step S03). Here, the control unit 30b performs allocation of the communication resource in accordance with movement or a change in location of the communication terminal 10. In some cases, the allocation of the communication resource may not change.

The control unit 30b notifies the wireless access point 20 of calculated communication resource allocation as a control signal (step S04). The wireless access point 20 executes allocation of a communication resource depending on the location of the communication terminal 10 in accordance with the control signal (step S05). That is, when receiving a control signal for changing the allocation of the communication resource due to movement or a change in location of the communication terminal 10, the wireless access point 20 performs changes of band allocation, beamforming, and the optical axis in accordance with the control signal. On the other hand, when receiving a control signal that does not change the allocation of the communication resource even in movement or a change in location of the communication terminal 10, the wireless access point 20 does not perform changes of band allocation, beamforming, and the optical axis in accordance with the control signal.

As described above, the communication system can implement advanced network control (pinpoint network resource allocation corresponding to physical location, and the like) by performing highly accurate indoor location by utilizing sensing data collected with low delay.

Therefore, the communication system can perform precise network control (pinpoint beamforming, resource allocation, and the like) depending on the location, density, moving direction, moving speed, and the like of the person/terminal on the basis of real-time terminal location information collected at a low load without adding a physical additional function (visible light communication or the like) to the terminal.

### Second Embodiment

The controller 30 can also be implemented by a computer and a program, and the program can be recorded in a recording medium or provided through a network.

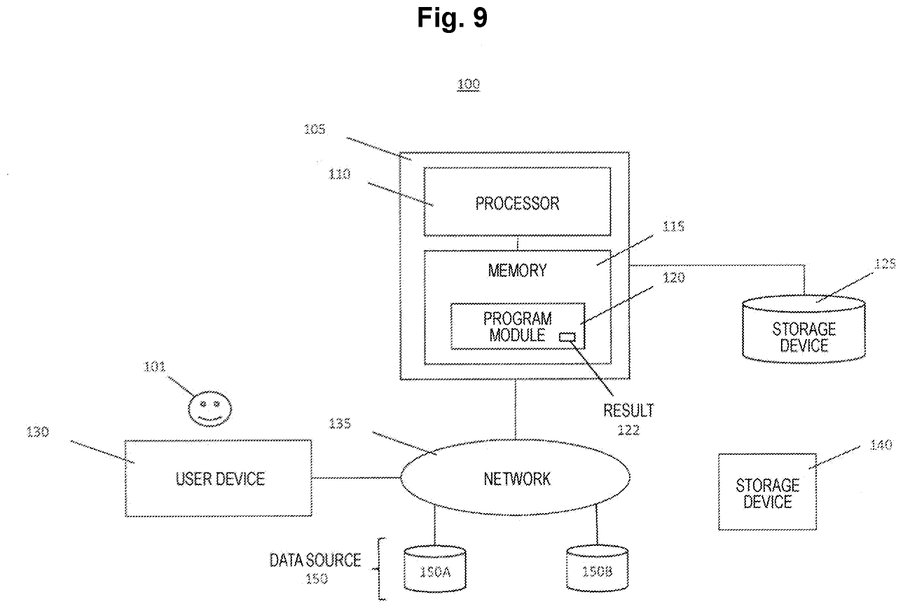

FIG. 9 illustrates a block diagram of a system 100. The system 100 includes a computer 105 connected to a network 135.

The network 135 is a data communication network. The network 135 may be a private network or a public network, and may include any or all of (a) a personal area network, for example, covering a room, (b) a local area network, for example, covering a building, (c) a campus area network, for example, covering a campus, (d) a metropolitan area network, for example, covering a city, (e) a wide area network, for example, covering an area connected across boundaries of cities, rural areas, or countries, and (f) the Internet. Communication is performed by an electronic signal and an optical signal via the network 135.

The computer 105 includes a processor 110 and a memory 115 connected to the processor 110. In the present specification, the computer 105 is represented as a standalone device. On the other hand, the computer is not limited thereto, and may be connected to other devices (not illustrated) in a distributed processing system.

The processor 110 is an electronic device including a logic circuit that responds to a command and executes the command.

The memory 115 is a tangible computer-readable storage medium in which a computer program is encoded. In this regard, the memory 115 stores data and commands, that is, program codes, that are readable and executable by the processor 110 to control operation of the processor 110. The memory 115 can be implemented by a random access memory (RAM), a hard drive, a read-only memory (ROM), or a combination thereof. One of the components of the memory 115 is a program module 120.

The program module 120 includes commands for controlling the processor 110 to perform processes described in the present specification. In the present specification, although it is described that operation is executed by the computer 105, a method, a process, or a sub-process thereof, the operation is actually executed by the processor 110.

In the present specification, the term “module” is used to refer to functional operation that may be embodied one of as a stand-alone component or as an integrated configuration of a plurality of sub-components. Thus, the program module 120 can be implemented as a single module or as a plurality of modules that operate in cooperation with each other. Further, in the present specification, although the program module 120 is described as being installed in the memory 115 and thus implemented in software, the program module 120 can be implemented in any of hardware (for example, an electronic circuit), firmware, software, or a combination thereof.

Although the program module 120 is illustrated as already being loaded into the memory 115, the program module 120 may be configured to be provided on a storage device 140 so as to be subsequently loaded into the memory 115. The storage device 140 is a tangible computer-readable storage medium that stores the program module 120. Examples of the storage device 140 include a compact disk, a magnetic tape, a read-only memory, an optical storage medium, a hard drive or a memory unit including a plurality of parallel hard drives, and a universal serial bus (USB) flash drive. Alternatively, the storage device 140 may be a random access memory or another type of electronic storage device provided in a remote storage system (not illustrated) and connected to the computer 105 via the network 135.

The system 100 further includes a data source 150A and a data source 150B which are collectively referred to herein as a data source 150 and are communicatively connected to the network 135. In practice, the data source 150 may include any number of data sources, that is, one or more data sources. The data source 150 may include unstructured data and may include social media.

The system 100 further includes a user device 130 operated by a user 101 and connected to the computer 105 via the network 135. Examples of the user device 130 include an input device, such as a keyboard or a voice recognition subsystem, for enabling the user 101 to input information and command selections to the processor 110. The user device 130 further includes an output device such as a display device, a printer, or a speech synthesizer. A cursor control unit such as a mouse, a trackball, or a touch-sensitive screen allows the user 101 to manipulate a cursor on the display device to input further information and command selections to the processor 110.

The processor 110 outputs a result 122 of execution of the program module 120 to the user device 130. Alternatively, the processor 110 can provide the output to a storage device 125 such as a database or a memory or to a remote device (not illustrated) via the network 135.

For example, a program that performs processing illustrated in a flowchart of FIG. 8 may be used as the program module 120. The system 100 can be operated as the controller 30.

The term “include . . . ” or “including . . . ” specifies that the mentioned features, integers, steps, or components are present, but should be understood as not excluding the presence of one or more other features, integers, steps, or components, or groups thereof. The terms “a” and “an” are indefinite articles for an object and therefore do not exclude embodiments including a plurality of objects.

### Other Embodiments

Note that the present invention is not limited to the above embodiments, and various modifications can be made without departing from the gist of the present invention. In short, the present invention is not limited to the specific embodiments, and in the implementation stage, the components may be modified and embodied without departing from the scope of the present invention.

In addition, various inventions can be made by appropriately combining a plurality of components disclosed in the above embodiments. For example, some components may be deleted from all the components illustrated in the embodiments. Further, components in different embodiments may be appropriately combined.

### Reference Signs List

5 Arbitrary area
10 Communication terminal
20 Access point
25 Light source
26 Sensor
27 Beacon device
30 Controller
30a Data collection analysis unit
30b Control unit
31 Reception unit
35 Communication control device
100 System
101 User
105 Computer
110 Processor
115 Memory
120 Program module
122 Result
125 Storage device
130 User device
135 Network
140 Storage device
150 Data source

1. A communication control device comprising:
a reception unit that receives information of a location metadata source from a communication terminal in an arbitrary area; and
a controller that calculates a location of the communication terminal in the arbitrary area on a basis of the information of the location metadata source and allocates a communication resource depending on the location of the communication terminal.

2. The communication control device according to claim 1, wherein a low layer communication protocol is used for communication of the information of the location metadata source.

3. The communication control device according to claim 1, wherein the reception unit also receives acceleration acquired by the communication terminal together with the information of the location metadata source.

4. A communication control method comprising:
receiving information of a location metadata source from a communication terminal in an arbitrary area;
calculating a location of the communication terminal in the arbitrary area on a basis of the information of the location metadata source; and
allocating a communication resource depending on the location of the communication terminal.

5. The communication control method according to claim 4, wherein a low layer communication protocol is used for communication of the information of the location metadata source.

6. The communication control method according to claim 4, wherein acceleration acquired by the communication terminal is also received together with the information of the location metadata source.

7. A communication system comprising:
the location metadata source in the arbitrary area; and
the communication control device according to claim 1.

8. A non-transitory computer-readable medium having computer-executable instructions that, upon execution of the instructions by a processor of a computer, cause the computer to function as the communication control device according to claim 1.
